(19) United States
(12) Patent Application Publication
(10) Pub. No.: US 2026/0204615 A1
(43) Pub. Date: Jul. 16, 2026

(54) BATTERY CELL AND BATTERY

(71) Applicant: ZHUHAI COSMX BATTERY CO., LTD., Zhuhai (CN)

(72) Inventors: Yi He, Zhuhai (CN); Chenghai Yang, Zhuhai (CN); Xiaofei Xu, Zhuhai (CN); Yuxiang Zeng, Zhuhai (CN)

(21) Appl. No.: 19/136,283

(22) PCT Filed: Mar. 14, 2024
(86) PCT No.: PCT/CN2024/081767

§ 371 Date: Jun. 5, 2025

(30) Foreign Application Priority Data
Jun. 29, 2023 (CN) 202321696943.3
Sep. 11, 2023 (CN) 202322461015.5

(51) Int. Cl. H01M 10/04; H01M 50/595

(52) U.S. Cl. CPC H01M 10/0431; H01M 50/595

(57) ABSTRACT

The present application provides a battery cell and a battery. The battery cell includes a first electrode plate, a first separator, a second electrode plate, and a second separator which are stacked in sequence, where at least one of a head portion and a tail portion of the first electrode plate is provided with an uncoated foil surface, the uncoated foil surface facing the first separator and being provided with an adhesive layer via which the first separator is bonded to the first electrode plate, such that the battery cell can be wound as a whole, thereby avoiding problems such as wrinkling and electrode plate misalignment at the beginning and end of a winding process, and improving product yield.

The present application claims the priority to Chinese Patent Application No. 202321696943.3, filed with the China National Intellectual Property Administration on Jun. 29, 2023 and Chinese Patent Application No. 202322461015.5, filed with the China National Intellectual Property Administration on Sep. 11, 2023, which are incorporated herein by reference in their entireties.

### TECHNICAL FIELD

The present application relates to the technical field of batteries, and in particular to a battery cell and a battery.

### BACKGROUND ART

Rechargeable batteries, also referred to as secondary batteries, are electrochemical energy storage devices that can be used for charge and discharge cycles, such as lithium-ion batteries, and are widely used in various mobile power supply devices, including consumer electronic products, new energy vehicles, and energy storage devices.

In the related art, a lithium battery generally includes a battery cell and a casing. The battery cell is disposed within the casing and includes a positive electrode plate and a negative electrode plate. A separator is disposed between the positive electrode plate and the negative electrode plate. The stacked positive electrode plate, negative electrode plate, and separator may be wound.

However, in most existing battery cells, the negative electrode plate has a greater length than the positive electrode plate. As a result, during a winding process, the negative electrode plate wraps around the positive electrode plate. However, at the beginning and end of the winding process of a battery cell, the negative electrode plate cannot be fixed to the positive electrode plate or the separator, so that the negative electrode plate is in an unrestrained free state. This is likely to cause poor coverage or wrinkling, thereby affecting the product yield and posing safety risks.

### SUMMARY

In view of the foregoing problems, the embodiments of the present application provide a battery cell and a battery, aiming to solve the technical problem of, at the beginning and end of a winding process of a battery cell, an electrode plate being in an unrestrained free state, which is likely to cause poor coverage or wrinkling, thereby affecting the product yield and posing safety risks.

To achieve the above object, in a first aspect, the present application provides a battery cell, including a first electrode plate, a first separator, a second electrode plate and a second separator which are stacked in sequence.

At least one of a head portion and a tail portion of the first electrode plate has an uncoated foil surface, the uncoated foil surface facing the first separator and being provided with an adhesive layer via which the first separator is bonded to the first electrode plate.

In the battery cell provided by the present application, at least one of the head portion and the tail portion of the battery cell is provided with the adhesive layer, and the electrode plates and the separators are secured by means of the adhesive layer, such that the electrode plates and the separators can be wound as a whole, thereby avoiding problems such as wrinkling and misalignment of the first electrode plate at the beginning and end of the winding process, and improving product yield.

As an optional embodiment, the uncoated foil surface may include a first uncoated foil surface and a second uncoated foil surface, and the adhesive layer may include a first adhesive layer and a second adhesive layer; the first uncoated foil surface may be located at the head portion of the first electrode plate, and the first adhesive layer is bonded between the first uncoated foil surface and the first separator to form a first laminated region; and the second uncoated foil surface is located at the tail portion of the first electrode plate, and the second adhesive layer is bonded between the second uncoated foil surface and the first separator to form a second laminated region.

As an optional embodiment, the battery cell includes a third laminated region, which may be located between the first laminated region and the second laminated region in an X-direction, the first electrode plate, the first separator, the second electrode plate and the second separator in the third laminated region being sequentially bonded to one another.

As an optional embodiment, a plurality of third laminated regions may be provided, which are arranged at intervals in a winding direction of the battery cell.

As an optional embodiment, the battery cell includes a compensation region, a length of the first electrode plate corresponding to the compensation region is greater than a length of the second electrode plate corresponding to the compensation region, and the compensation region is located between adjacent third laminated regions.

As an optional embodiment, spacings between adjacent third laminated regions follow an increasing arithmetic progression from the head portion of the first electrode plate to the tail portion of the first electrode plate.

As an optional embodiment, the battery cell includes curved segments and straight segments connected alternately in the winding direction, the third laminated regions are located on the straight segments, and compensation regions are located on the curved segments.

As an optional embodiment, the first electrode plate may include a substrate and active layers, the active layers being coated on two side surfaces of the substrate, and the adhesive layer has a dimension T1 in a Y-direction that is smaller than a dimension T2 of each active layer in the Y-direction, where 0.001 mm<T1<0.5 mm.

As an optional embodiment, the adhesive layer may have a dimension greater than or equal to 2 mm in the X-direction.

In a second aspect, the present application provides a battery, including a casing and a battery cell in the technical solution described above, where the battery cell is disposed in the casing or in a pouch enclosure.

The present application provides a battery cell and a battery. The battery cell includes a first electrode plate, a first separator, a second electrode plate, and a second separator which are stacked in sequence, where at least one of a head portion and a tail portion of the first electrode plate is provided with an uncoated foil surface, the uncoated foil surface facing the first separator and being provided with an adhesive layer via which the first separator is bonded to the first electrode plate, thereby avoiding problems such as wrinkling and electrode plate misalignment of the first electrode plate at the beginning and end of a winding process, and improving product yield.

In addition to the technical problems solved by the present application described above, the technical features constituting the technical solutions and the beneficial effects brought about by the technical features of these technical solutions, other technical problems that can be solved by the battery cell and the battery provided by the present application, the other technical features included in the technical solutions and the beneficial effects brought about by these technical features will be further described in detail in the specific embodiments.

### BRIEF DESCRIPTION OF THE DRAWINGS

To describe the technical solutions in embodiments of the present application or in the prior art more clearly, the following briefly describes the accompanying drawings required for describing the embodiments or the prior art. It is clear that the accompanying drawings in the following descriptions are merely some embodiments of the present application, and those of ordinary skill in the art may still derive other drawings from these accompanying drawings without creative efforts.

FIG. 1 is a first schematic structural view of a battery cell according to an embodiment of the present application;

FIG. 2 is a schematic structural view of the battery cell in an unwound state according to an embodiment of the present application;

FIG. 3 is a schematic structural view of a first electrode plate of the battery cell according to an embodiment of the present application;

FIG. 4 is a partial schematic view of part C in FIG. 3;

FIG. 5 is another schematic structural view of the first electrode plate of the battery cell according to an embodiment of the present application;

FIG. 6 is a schematic view showing the distribution of third laminated regions of the battery cell according to an embodiment of the present application;

FIG. 7 is a first schematic structural view of an adhesive layer of the first electrode plate of the battery cell according to an embodiment of the present application;

FIG. 8 is a second schematic structural view of the adhesive layer of the first electrode plate of the battery cell according to an embodiment of the present application;

FIG. 9 is a third schematic structural view of the adhesive layer of the first electrode plate of the battery cell according to an embodiment of the present application;

FIG. 10 is a partial schematic view of part A in FIG. 1;

FIG. 11 is a partial schematic view of a head portion of the battery cell according to an embodiment of the present application;

FIG. 12 is a second schematic structural view of the battery cell according to an embodiment of the present application;

FIG. 13 is a schematic enlarged structural view of part D in FIG. 12;

FIG. 14 is a schematic structural view of the battery cell before winding according to an embodiment of the present application;

FIG. 15 is a schematic enlarged structural view of part E in FIG. 14;

FIG. 16 is a schematic structural view showing a winding mandrel for winding the first electrode plate according to an embodiment of the present application; and

FIG. 17 is a schematic structural view of a wound first electrode plate according to an embodiment of the present application.

### LIST OF REFERENCE SIGNS

10—battery cell; 11—first laminated region; 12—second laminated region; 13—third laminated region; 14—compensation region; 15—straight segment; 16—curved segment; 17—tab; 17a—first tab; 17b—second tab; 100—first electrode plate; 101—substrate; 102—active layer; 110—uncoated foil surface; 111—first uncoated foil surface; 112—second uncoated foil surface; 120—adhesive layer; 121—first adhesive layer; 122—second adhesive layer; 200—second electrode plate; 300—first separator; 400—second separator.

### DETAILED DESCRIPTION OF EMBODIMENTS

In order to make the objectives, technical solutions and advantages of the present application clearer, the technical solutions in the embodiments of the present application will be described clearly and completely below with reference to the accompanying drawings in the embodiments of the present application. Apparently, the embodiments described are some of, rather than all of, the embodiments of the present application. All other embodiments obtained by those of ordinary skill in the art based on the embodiments of the present application without creative efforts shall fall within the scope of protection of the present application.

Rechargeable batteries, also referred to as secondary batteries, are electrochemical energy storage devices that can be used for charge and discharge cycles, such as lithium-ion batteries, and are widely used in various mobile power supply devices, including consumer electronic products, new energy vehicles, and energy storage devices. A lithium battery generally includes a battery cell and a casing. The battery cell is disposed within the casing and includes a positive electrode plate and a negative electrode plate. A separator is disposed between the positive electrode plate and the negative electrode plate. The stacked positive electrode plate, negative electrode plate, and separator may be wound. However, in the structure of a conventional battery cell, at the beginning and end of a winding process, an electrode plate is in an unconstrained free state, which is likely to cause poor coverage, electrode plate misalignment, or wrinkling, thereby affecting the product yield and posing safety risks. The present application provides a battery cell and a battery. A bonding structure designed for a second electrode plate and a first electrode plate of the battery cell during winding helps to secure the electrode plates and separators, ensuring that the electrode plates and the separators form an integrated structure during winding of the battery cell, preventing problems such as wrinkling and misalignment of the first and second electrode plates at the beginning and end of the winding process of the battery cell, thereby improving the product yield.

The battery cell and the battery of the embodiments of the present application will be described below with reference to the accompanying drawings. It should be noted that the battery cell according to the embodiments of the present application is applied to a battery, which may be a lithium battery. The lithium battery can be recharged and discharged for cyclic use. The battery cell and the battery can be applied in various scenarios, including, but not limited to, electronic products, energy storage devices, and vehicles, such as new energy vehicles and charging stations. The embodiments of the present application are not specifically limited thereto.

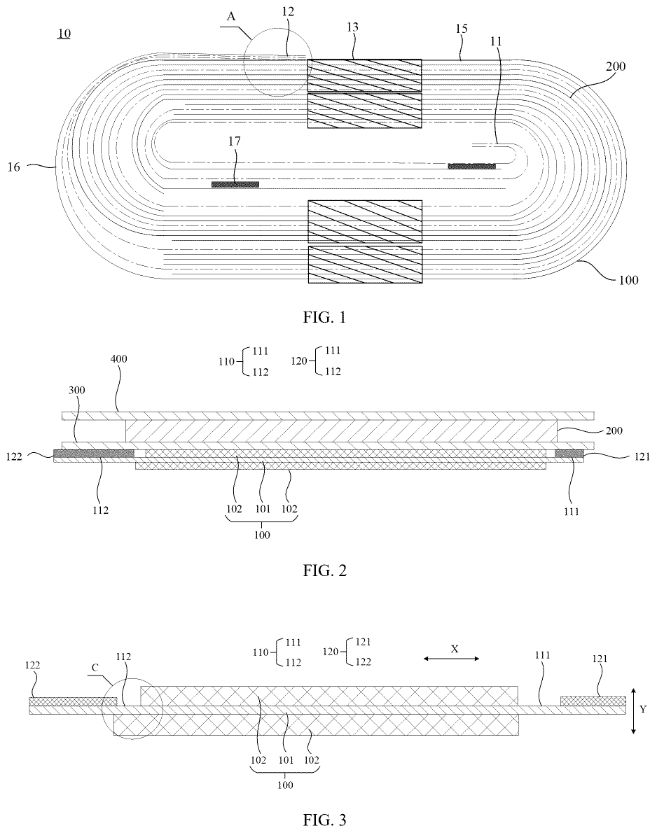

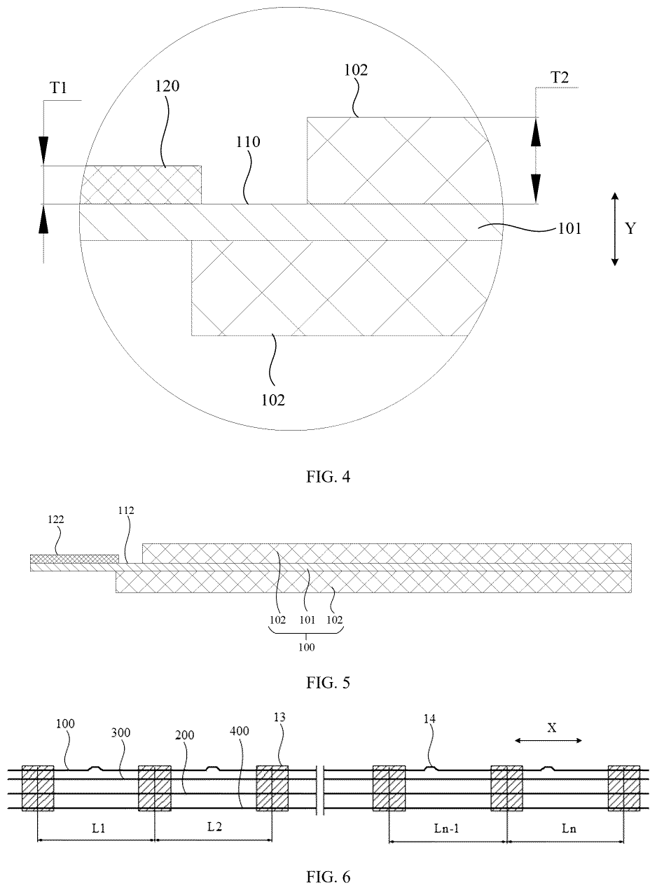

FIG. 1 is a first schematic structural view of the battery cell according to an embodiment of the present application, FIG. 2 is a schematic structural view of the battery cell in an unwound state according to an embodiment of the present application, FIG. 3 is a schematic structural view of a first electrode plate of the battery cell according to an embodiment of the present application, and FIG. 4 is a partial schematic view of part C in FIG. 3.

Referring to FIG. 1 to FIG. 4, the embodiments of the present application provide a battery cell 10, which may be of a wound configuration. The battery cell 10 includes a first electrode plate 100, a first separator 300, a second electrode plate 200 and a second separator 400 which are stacked in sequence. During winding of the battery cell 10, the first electrode plate 100, the first separator 300, the second electrode plate 200 and the second separator 400 are alternately stacked. The first separator 300 is disposed between the first electrode plate 100 and the second electrode plate 200, and the second separator 400 is disposed between the second electrode plate 200 and the first electrode plate 100.

A winding start end of the battery cell 10 is a head portion of the electrode plate, and a winding finish end of the battery cell 10 is a tail portion of the electrode plate. The head portion of the electrode plate is located at the center of the wound battery cell 10, and the tail portion of the electrode plate is located on an outer side of the wound battery cell 10. It will be appreciated that, since the battery cell 10 is formed by winding the first electrode plate 100, the first separator 300, the second electrode plate 200 and the second separator 400, the first electrode plate 100, the first separator 300, the second electrode plate 200 and the second separator 400 each have a head portion and a tail portion.

In some embodiments, at least one of the head portion and the tail portion of the first electrode plate 100 has an uncoated foil surface 110. The uncoated foil surface 110 faces the first separator 300, that is, the uncoated foil surface 110 is located on a side of the first electrode plate 100 facing the first separator 300. An adhesive layer 120 is provided on the uncoated foil surface 110, and the first separator 300 is bonded to the first electrode plate 100 via the adhesive layer 120. The uncoated foil surface 110 is a region where a surface of a current collector of the first electrode plate 100 is not coated with an active material.

It will be appreciated that before the winding of the battery cell 10, the first separator 300 may be bonded to the first electrode plate 100 via the adhesive layer 120, thereby securing the relative position of the first separator 300 and the first electrode plate 100. Accordingly, during the subsequent winding of the battery cell 10, misalignment or wrinkling of the first electrode plate 100 at the location of the uncoated foil surface 110 after winding can be prevented.

It should be noted that, in the battery cell 10 according to the present application, at least one of the head and tail portions is provided with an adhesive layer 120, the first electrode plate 100 and the first separator 300 are secured by means of the adhesive layer 120, and at a central portion of the battery cell 10 in an extension direction, the first electrode plate 100, the first separator 300, the second electrode plate 200 and the second separator 400 may be bonded together by means of hot pressing, such that the electrode plates and the separators can be wound as a whole, thereby preventing wrinkling and misalignment of the first electrode plate 100 at the beginning and end of the winding process, and improving the product yield.

Furthermore, in the embodiments of the present application, one of the first electrode plate 100 and the second electrode plate 200 may be a positive electrode plate and the other may be a negative electrode plate. For example, the first electrode plate 100 is a positive electrode plate and the second electrode plate 200 is a negative electrode plate, or the first electrode plate 100 is a negative electrode plate and the second electrode plate 200 is a positive electrode plate. The embodiments of the present application are not specifically limited thereto.

FIG. 5 is another schematic structural view of the first electrode plate of the battery cell according to an embodiment of the present application.

Referring to FIG. 5 in combination with FIG. 1, in some embodiments, an adhesive portion may be provided at only one of the head portion or the tail portion of the first electrode plate 100. For example, an adhesive layer 120 may be provided at the head portion of the first electrode plate 100, such that an uncoated foil surface at the head portion of the first electrode plate 100 can be bonded to a head portion of the first separator 300 via the adhesive layer 120, thereby securing the head portion of the first electrode plate 100 relative to the first separator 300. Of course, it is also possible that the adhesive layer 120 is provided at the tail portion of the first electrode plate 100, such that an uncoated foil surface at the tail portion of the first electrode plate 100 can be bonded to a tail portion of the first separator 300 via the adhesive layer 120. Details thereof are not repeated herein.

Referring to FIG. 1 to FIG. 4, in some other embodiments, both the head and tail portions of the first electrode plate 100 may be secured via the adhesive layer 120. The uncoated foil surface 110 may include a first uncoated foil surface 111 and a second uncoated foil surface 112, and the adhesive layer 120 may include a first adhesive layer 121 and a second adhesive layer 122.

It will be appreciated that the first uncoated foil surface 111 may be located at the head portion of the first electrode plate 100, and the first adhesive layer 121 is bonded between the first uncoated foil surface 111 and the first separator 300 to form a first laminated region 11; and the second uncoated foil surface 112 is located at the tail portion of the first electrode plate 100, and the second adhesive layer 122 is bonded between the second uncoated foil surface 112 and the first separator 300 to form a second laminated region 12.

In an embodiment of the present application, the battery cell 10 includes a third laminated region 13. The third laminated region 13 may be located between the first laminated region 11 and the second laminated region 12 in an X-direction. The first electrode plate 100, the first separator 300, the second electrode plate 200 and the second separator 400 in the third laminated region 13 are bonded in sequence, such that the first electrode plate 100, the first separator 300, the second electrode plate 200 and the second separator 400 are sequentially bonded to one another to form an integrated structure, thereby avoiding misalignment and wrinkling during the winding process.

It should be noted that the first electrode plate 100, the first separator 300, the second electrode plate 200 and the second separator 400 may be laminated using heating and pressurizing, or by using the adhesive layer. Heating and pressurizing are preferred for lamination, so that empty foil regions on the electrode plates can be reduced, thereby preventing a decrease in energy density.

The specific arrangement of the third laminated region 13 will be described in detail below.

FIG. 6 is a schematic view showing the distribution of third laminated regions of the battery cell according to an embodiment of the present application.

Referring to FIG. 6 in combination with FIG. 1 to FIG. 4, in one possible embodiment, a plurality of third laminated regions 13 may be provided. The plurality of third laminated regions 13 are arranged at intervals along a winding direction of the battery cell 10. In this way, in a length direction of the battery cell 10, the third laminated regions 13 may be present at different positions, and the first electrode plate 100, the first separator 300, the second electrode plate 200 and the second separator 400 are bonded to one another at different locations along the length direction of the battery cell 10.

The battery cell 10 includes a compensation region 14. A length of the first electrode plate 100 corresponding to the compensation region 14 is greater than a length of the second electrode plate 200 corresponding to the compensation region 14; the compensation region 14 may be located between adjacent third laminated regions 13; during the winding of the battery cell 10, the second electrode plate 200 is located on an inner side of the battery cell 10, and the first electrode plate 100 is located on an outer side of the battery cell 10; and the compensation region 14 enables the first electrode plate 100, located on the outer side of the battery cell 10 in the winding direction, to have a longer dimension, thereby preventing the first electrode plate 100 from being stretched and broken, and preventing the second electrode plate 200 from being compressed and wrinkling.

It will be appreciated that when the battery cell 10 is in an unwound state, with head and tail ends of the first electrode plate 100 and the second electrode plate 200 are flush, the compensation region 14 forms a raised region on the first electrode plate 100, and during the winding of the battery cell 10, a smooth surface can be formed at the compensation region 14 on the first electrode plate 100.

In some embodiments, spacings between adjacent third laminated regions 13 follow an increasing arithmetic progression from the head portion of the first electrode plate 100 to the tail portion of the first electrode plate 100, so that the spacing between the middle laminated regions gradually increases in a regular pattern. Referring to FIG. 1, as the number of winding turns of the battery cell 10 increases during the winding of the battery cell 10, the length required for one winding turn on the inner side of the battery cell 10 is shorter than the length required for one winding turn on the outer side of the battery cell 10. Therefore, the gradually increasing spacing between the third laminated regions 13 allows the third laminated regions 13 to correspond to each other after finishing each winding turn, and the compensation regions 14 can also correspond to each other.

By way of example, referring to FIG. 6, starting from a head portion of the battery cell 10, the spacing between the first third laminated region 13 and the second third laminated region 13 is defined as L1, the spacing between the second third laminated region 13 and the third third laminated region 13 is defined as L2, and so on. From the head portion of the battery cell 10 to the tail portion of the battery cell 10, the spacings between adjacent third laminated regions 13 are sequentially defined as L1, L2, L3 . . . Ln-1, Ln, where L1, L2, L3 . . . Ln-1 and Ln follow an arithmetic progression.

It should be noted that the battery cell 10 includes curved segments 16 and straight segments 15 which are alternately connected in sequence in the winding direction. The third laminated regions 13 are located on the straight segments 15, and the compensation regions 14 are located on the curved segments 16. On the straight segments 15, the length of the first electrode plate 100 and the length of the second electrode plate 200 correspond to each other, so that the first electrode plate 100, the first separator 300, the second electrode plate 200 and the second separator 400 are reliably bonded to each other in sequence by means of the middle laminated regions. On the curved segments 16, the first electrode plate 100 located on an outer side of the curved segments 16 has a larger dimension than the second electrode plate 200 located on an inner side of the curved segments 16. Therefore, the compensation regions 14 can serve to compensate for a length difference between the first electrode plate 100 and the second electrode plate 200, thereby preventing breakage or wrinkling during winding.

The dimensions and structure of the adhesive layer 120, and the specific arrangement positions of the adhesive layer at the head portion and the tail portion of the first electrode plate 100 will be described below in detail.

Referring to FIG. 1 to FIG. 4, in one possible embodiment, the first electrode plate 100 may include a substrate 101 and active layers 102. The active layers 102 are coated on two side surfaces of the substrate 101. In a region where the uncoated foil surface is located, only the substrate 101 is provided, with no active layer 102 coated. In other words, the uncoated foil surface is formed at an end portion of the first electrode plate 100 where no active layer 102 is coated.

It will be appreciated that a dimension T1 of the adhesive layer 120 in a Y-direction is smaller than a dimension T2 of the active layer 102 in the Y-direction, i.e., T1<T2. The adhesive layer 120 may cover at least part of the uncoated foil surface. The specific coverage area of the adhesive layer 120 is not limited in the embodiments of the present application.

By way of example, the dimension T1 of the adhesive layer 120 in the Y-direction may range from 0.001 mm to 0.5 mm, i.e. 0.001 mm<T1<0.5 mm. A specific value of the dimension T1 of the adhesive layer 120 in the Y-direction may include, but is not limited to, 0.001 mm, 0.002 mm, 0.01 mm, 0.1 mm, 0.4 mm, and 0.5 mm. The embodiments of the present application do not limit the specific thickness value of the adhesive layer 120.

In some embodiments, the adhesive layer 120 may be an adhesive-coated layer, and the coated shape of the adhesive layer 120 may include, but is not limited to, square, circular, and oval shape. The adhesive layer 120 may form a complete coated region, or may form a plurality of separate coated regions. The embodiments of the present application are not specifically limited thereto.

By way of example, the material of the adhesive layer 120 may be one or more of cellulose, polyvinylidene fluoride-co-hexafluoropropylene, polyvinylidene fluoride-co-trichloroethylene, polyacrylate, polyacrylonitrile, polyvinylpyrrolidone, polyvinyl acetate, polyethylene-vinyl acetate copolymer, polyethylene oxide, polyarylate, cellulose acetate, polyethylene-propylene copolymer, cyanoethyl pullulan, cyanoethyl polyvinyl alcohol, cyanoethyl cellulose, carboxymethyl cellulose, polypropylene-maleic anhydride, and styrene-polyisoprene.

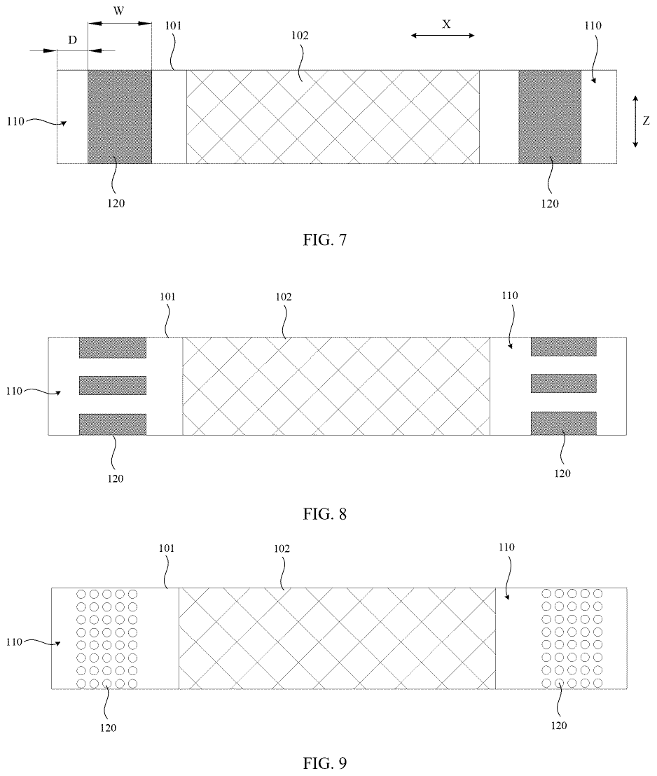

FIG. 7 is a first schematic structural view of an adhesive layer of the first electrode plate of the battery cell according to an embodiment of the present application.

Referring to FIG. 7, by way of example, the adhesive layer 120 may form a complete coated region. The dimension of the adhesive layer 120 in a Z-direction of the first electrode plate 100 may be equal to the dimension of the first electrode plate 100 in the Z-direction; two sides of the adhesive layer 120 are flush with two sides of the first electrode plate 100 in the Z-direction; and the dimension of the adhesive layer 120 in the X-direction of the first electrode plate 100 may be less than or equal to the dimension of the uncoated foil surface in the X-direction. For example, a spacing between an edge of the adhesive layer 120 on the side away from the active layer 102 and an edge of the uncoated foil surface on the side away from the active layer 102 is defined as D, where D≥0. When D is equal to 0, the edge of the adhesive layer 120 on the side away from the active layer 102 is flush with the edge of the uncoated foil surface on the side away from the active layer 102; and when D>0, there is a gap between the edge of the adhesive layer 120 on the side away from the active layer 102 and the edge of the uncoated foil surface on the side away from the active layer 102.

In addition, a dimension W of the adhesive layer 120 in the X-direction may be greater than or equal to 2 mm, i.e., W≥2 mm, and a specific value of the dimension W of the adhesive layer 120 in the X-direction may include, but is not limited to, 2 mm, 2.1 mm, 3 mm, 4 mm, and 5 mm, as long as the value of W is less than or equal to the dimension of the uncoated foil surface in the X-direction.

FIG. 8 is a second schematic structural view of the adhesive layer of the first electrode plate of the battery cell according to an embodiment of the present application.

Referring to FIG. 8, by way of example, the adhesive layer 120 may include a plurality of elongated bonding regions that may be distributed at intervals on the uncoated foil surface along a width direction of the first electrode plate 100. The number of bonding regions may be two, three, four or more. The embodiments of the present application are not specifically limited thereto.

FIG. 9 is a third schematic structural view of the adhesive layer of the first electrode plate of the battery cell according to an embodiment of the present application.

Referring to FIG. 9, by way of example, the adhesive layer 120 may include a plurality of bonding points that may be arranged in an array on the uncoated foil surface. The specific number and arrangement of the bonding points are not specifically limited in the embodiments of the present application.

It should be noted that the adhesive layer 120 at the head portion or the tail portion of the first electrode plate 100 can use the same dimensions and structure as the adhesive layer 120 described above. This will not be elaborated further.

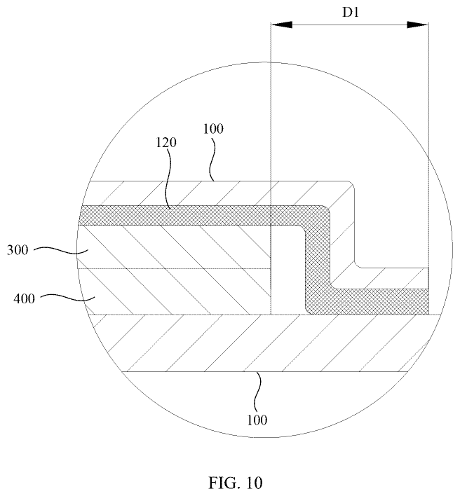

FIG. 10 is a partial schematic view of part A in FIG. 1.

Referring to FIG. 10 in combination with FIG. 1 to FIG. 4, in some embodiments, the tail portion of the first electrode plate 100 extends beyond the tail portion of the first separator 300 by a distance D1. When D1 is equal to 0, the first electrode plate 100 and the first separator 300 are fully adhered together, with the tail portions thereof being flush. When D1 is greater than 0, a portion of the uncoated foil surface at the tail portion of the first electrode plate 100 is bonded to the first separator 300 via the first adhesive layer 121, and a portion of the uncoated foil surface at the tail portion of the first electrode plate 100 that extends beyond the first separator 300 is bonded to a previous layer of wound first electrode plate 100 via the first adhesive layer 121.

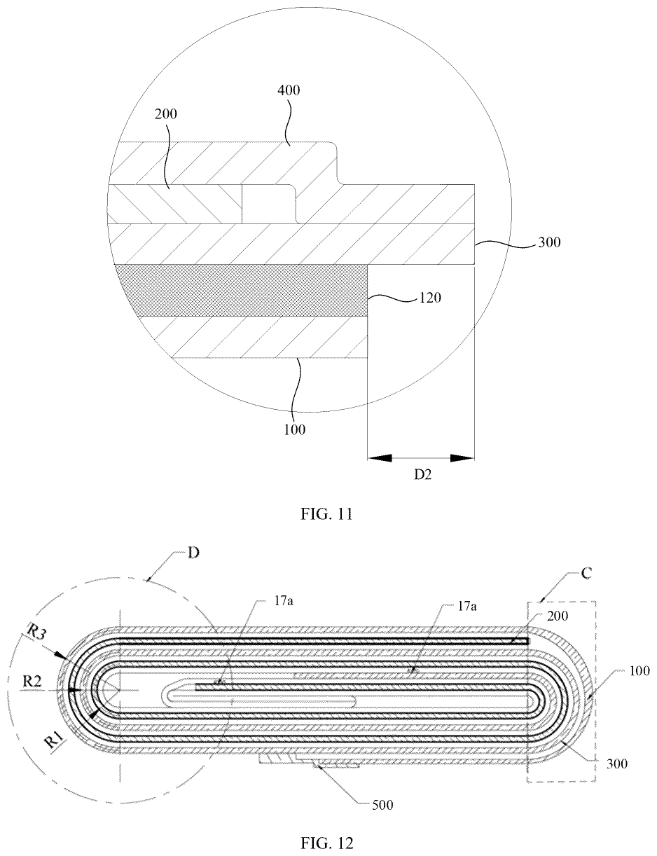

FIG. 11 is a partial schematic view of a head portion of the battery cell according to an embodiment of the present application.

Referring to FIG. 11 in combination with FIG. 1 to FIG. 4, in some embodiments, the head portion of the first separator 300 extends beyond the head portion of the first electrode plate 100 by a distance D2. When D2 is equal to 0, the first electrode plate 100 is flush with the tail portion of the first separator 300. When D2 is greater than 0, the uncoated foil surface at the head portion of the first electrode plate 100 is bonded to the first separator 300 via the first adhesive layer 121, and the head portion of the first separator 300 extends beyond the edge of the head portion of the first electrode plate 100 by a distance.

In addition, the first electrode plate 100 and the second electrode plate 200 may be connected to tabs 17, respectively. One of the tabs 17 of the two is a positive tab and the other is a negative tab.

A specific process for manufacturing the battery cell 10 will be illustrated below by way of example.

In step I, a first electrode plate 100 is fabricated, an active material is coated on upper and lower surfaces of a substrate of the first electrode plate 100, and a blank region, where no active material is coated, is reserved on at least one of a head portion and a tail portion of the first electrode plate 100 according to actual needs, to form an uncoated foil surface.

In step II, an adhesive material is applied to the uncoated foil surface at the head portion or the tail portion of the first electrode plate 100 to form a first adhesive layer 121 or a second adhesive layer 122.

In step III, head portions or tail portions of the first electrode plate 100, the first separator 300, the second electrode plate 200 and the second separator 400 are laminated, in accordance with a predetermined positional relationship, into an integrated structure by heating and pressurizing, or the head portions and the tail portions are synchronously laminated into an integrated structure.

In step IV, middle portions of the first electrode plate 100, the first separator 300, the second electrode plate 200 and the second separator 400 are laminated, in accordance with a predetermined positional relationship, into an integrated structure by heating and pressurizing to form third laminated regions 13, where the third laminated regions 13 are discontinuous, and the distances between adjacent third laminated regions 13 follow an increasing arithmetic progression.

In step V, the laminated electrode plates are wound to obtain the battery cell 10.

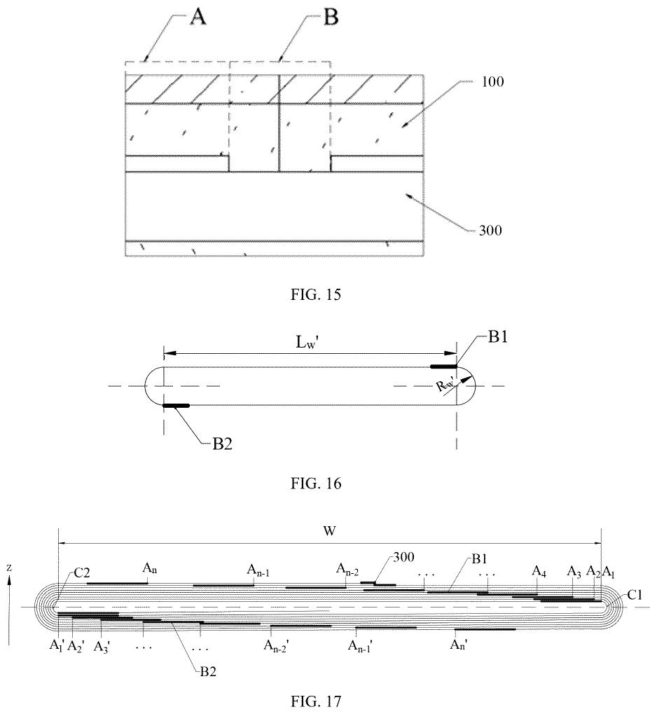

Referring to FIG. 12 to FIG. 15, this embodiment provides a battery cell, including a first electrode plate 100, a second electrode plate 200, a first separator 300 and a second separator 400 which are stacked and wound. The first separator 300 and the second separator 400 are located on two sides of the second electrode plate 200, respectively, and the first separator 300 is located between the first electrode plate 100 and the second electrode plate 200. The first separator 300 and the second separator 400 can isolate the second electrode plate 200, to prevent the second electrode plate 200 from coming into contact with the first electrode plate 100, thereby avoiding a short circuit. In this embodiment, the number of first separators 300 may be one or at least two; and the number of second separators 400 may be one, or at least two. The number of first separators 300 and the number of second separators 400 may be the same or different, and no further limitation is imposed in this embodiment.

Along a length direction of the first electrode plate 100 (i.e., an x-axis direction in FIG. 14), the first electrode plate 100, the second electrode plate 200, the first separator 300 and the second separator 400 are connected to form at least one third laminated region B. One non-third laminated region A is formed between any two adjacent third laminated regions B. In the third laminated region B, the first electrode plate 100, the second electrode plate 200, the first separator 300 and the second separator 400 are laminated together to prevent the first electrode plate 100 from shifting, displacement, etc.; and in the non-third laminated region A, the first electrode plate 100, the second electrode plate 200, the first separator 300 and the second separator 400 are not laminated together, to avoid breakage of the first electrode plate 100 due to tensile force, or bulging of the second electrode plate 200. As an optional embodiment, the first electrode plate 100, the second electrode plate 200, the first separator 300 and the second separator 400 may be bonded together by thermal lamination, thereby achieving lamination between the first electrode plate 100, the second electrode plate 200, the first separator 300 and the second separator 400. The first electrode plate 100, the second electrode plate 200, the first separator 300 and the second separator 400 may alternatively be bonded and secured together by using an adhesive tape, glue, or an adhesive layer, thereby achieving lamination between the first electrode plate 100, the second electrode plate 200, the first separator 300 and the second separator 400. The first electrode plate 100, the second electrode plate 200, the first separator 300 and the second separator 400 being not laminated together means that the first electrode plate 100, the second electrode plate 200, the first separator 300 and the second separator 400 are not bonded into an integrated structure.

Along the length direction of the first electrode plate 100, the first electrode plate 100 includes a plurality of bend regions C and a plurality of straight regions (regions between the bend regions C) arranged alternately and connected in sequence. The bend regions C are regions where the first electrode plate 100 is bent when being wound to form a battery cell. The straight regions are regions where the first electrode plate 100 is not bent when being wound to form the battery cell. The third laminated regions B are located in the straight regions. Preferably, in this embodiment, the first electrode plate 100, the second electrode plate 200, the first separator 300 and the second separator 400 are connected to form a plurality of third laminated regions B, and one non-third laminated region A is formed between any two adjacent third laminated regions B.

In the battery cell of this embodiment, along the length direction of the first electrode plate 100, a plurality of third laminated regions B and non-third laminated regions A are alternately arranged and sequentially connected between the first electrode plate 100 and the first separator 300. In the third laminated regions B, the first electrode plate 100, the second electrode plate 200, the first separator 300 and the second separator 400 are connected, so that the first electrode plate 100 can be prevented from shifting or displacement. The first electrode plate 100, the first separator 300, the second electrode plate 200 and the second separator 400 are laminated into an integrated structure, so that not only the bonding strength between the first electrode plate 100, the second electrode plate 200, the first separator 300 and the second separator 400 can be increased to reduce the risk of failure caused by dropping of a battery assembly, but deviation correction and plate feeding mechanisms of a winding device can also be simplified, thereby simplifying the winding device and facilitating a reduction of production costs. In addition, in the non-third laminated regions A, the first electrode plate 100, the second electrode plate 200, the first separator 300 and the second separator 400 are not connected. The third laminated regions B are all located in the straight regions, so as to prevent the third laminated regions B from being located in the bend regions C. As a result, there is a length deviation between the first electrode plate 100 and the second electrode plate 200 at the bend regions C. The connected first electrode plate 100 and second electrode plate 200, during the winding process, can alleviate the risk of breakage of the first electrode plate 100 caused by tensile force or bulging of the second electrode plate 200, thereby facilitating an improvement in the safety performance of the battery cell.

In this embodiment, the first electrode plate 100 may include a first current collector and first active material layers disposed on two side surfaces of the first current collector. A material of the first current collector includes, but is not limited to, a metal foil, an alloy foil, and a metal and polymer composite foil. By way of example, the first current collector may be made of aluminum, nickel, titanium, etc. An active material of the first active material layer includes, but is not limited to, lithium transition metal composite oxides.

The second electrode plate 200 may include a second current collector and second active material layers disposed on two side surfaces of the second current collector. A material of the second current collector includes, but is not limited to, a metal foil, an alloy foil, and a metal and polymer composite foil. By way of example, the second current collector may be made of copper, nickel, stainless steel, etc. An active material of the second active material layer is one or more of graphite, hard carbon, soft carbon, lithium titanate and silicon-based materials.

In this embodiment, along the length direction of the first electrode plate 100, the spacing between any two adjacent third laminated regions B is the same. Referring to FIG. 14, along the length direction of the first electrode plate 100, the spacing between the first third laminated region B and the second third laminated region B is defined as L1, and the spacing between the second third laminated region B and the third third laminated region B is defined as L2. By analogy, the spacing between the (N-1)th third laminated region and the Nth third laminated region B is defined as Ln, where L1=L2= . . . =Ln.

Based on the above embodiments, half an outer circumference of a winding mandrel for winding the battery cell is defined as Lw. That is, as shown in FIG. 16, Lw=Lw′+π×Rw′, then L1=L2= . . . =Ln=Lw, so as to avoid the presence of the third laminated region B in the bend region C, thereby ensuring that the third laminated regions B are located in the straight regions.

In this embodiment, along the length direction of the first electrode plate 100, the lengths of the plurality of third laminated regions B are all equal, and the lengths of the third laminated regions B may be set to a constant value. Those skilled in the art can set the lengths of the third laminated regions according to actual requirements. As an optional embodiment, the third laminated region B has a length of 5 mm to 10 mm. By way of example, the third laminated region B has a length of 5 mm, 6 mm, 7 mm, 8 mm, 9 mm or 10 mm.

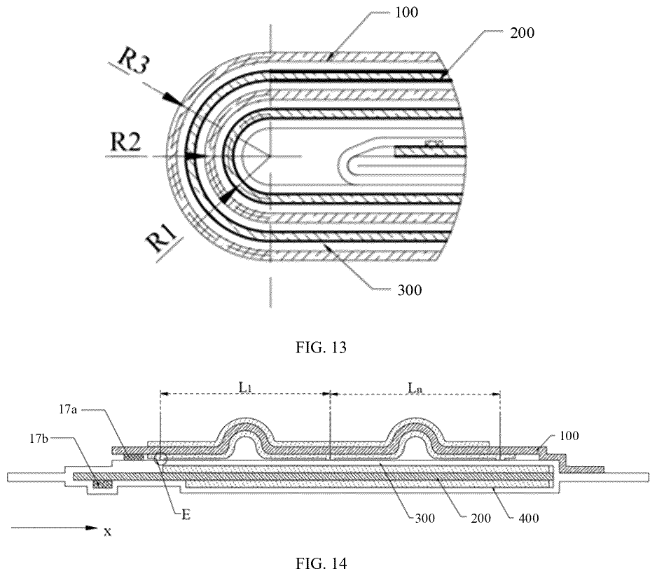

The battery cell includes a plurality of winding turns. During the winding process of the first electrode plate 100 and the second electrode plate 200 into the battery cell, there is a difference in radius between the first electrode plate 100 and the second electrode plate 200 at the bend region C in the same winding turn. This difference may cause the first electrode plate 100 to break due to tensile force or result in bulging of the second electrode plate 200 during the winding process. To further alleviate this problem, as shown in FIG. 13 and FIG. 14, based on the above embodiment, along the length direction of the first electrode plate 100, between any two adjacent third laminated regions B, the length of the first electrode plate 100 is greater than that of the second electrode plate 200. In this way, the length of the first electrode plate 100 being greater than that of the second electrode plate 200 can achieve length compensation for the first electrode plate 100, reducing the length difference between the first electrode plate 100 and the second electrode plate 200 at the bend region C, and preventing breakage of the first electrode plate 100 caused by tensile force or bulging of the second electrode plate 200. Preferably, along the length direction of the first electrode plate 100, a length difference between the first electrode plate 100 and the second electrode plate 200 between any two adjacent third laminated regions B is defined as La, La=π×a, where a=R2−R1, R1 represents the radius of the second electrode plate 200 of the (N-1)th winding turn with the center at the bend region C, and R2 represents the radius of the first electrode plate 100 of the (N-1)th winding turn with the center at the bend region C. That is, a represents the sum of half the thickness of the first electrode plate 100, half the thickness of the second electrode plate 200, and the thickness of the first separator 300. In this way, defining the compensation length of the first electrode plate 100 as La can further prevent breakage of the first electrode plate 100 caused by tensile force or bulging of the second electrode plate 200.

As shown in FIG. 17, the battery cell includes N winding turns, where N is an integer greater than or equal to 1. Two third laminated regions B are provided in each winding turn. By dividing the battery cell along a central line (a dashed line shown in FIG. 17) in the thickness direction (a z-axis direction shown in FIG. 17) of the battery cell, the battery cell includes an upper side (i.e., second side) and a lower side (i.e., second side). In each winding turn, one third laminated region B is located on the upper side of the battery cell, and the other third laminated region B is located on the lower side of the battery cell. Projections of the two third laminated regions B in each winding turn in the thickness direction of the battery cell do not overlap. In order to facilitate the description of the technical solution of the present application, the third laminated region B located on the upper side of the battery cell in each winding turn is referred to as a first-side laminated region B1, and the third laminated region B located on the lower side of the battery cell in each winding turn is referred to as a second-side laminated region B2. Projections of the first-side laminated region B1 and the second-side laminated region B2 of each winding turn in the thickness direction of the battery cell do not overlap. This facilitates an improvement in the uniformity of the thickness of the battery cell, thereby reducing the thickness of the battery cell and facilitating an increase in the energy density of the battery cell.

It should be noted that one winding turn starts from a certain point on the battery cell as a start end, and extends one full turn along the winding direction to another point as a finish end. The finish end, the start end, and the center of the corresponding winding turn lie on the same straight line, with the start end located between the finish end and the center of the winding turn.

In this embodiment, on the upper side of the battery cell, N first-side laminated regions B1 are provided; and on the lower side of the battery cell, N second-side laminated regions B2 are provided. As the first electrode plate 100 is wound to form the battery cell, the winding radius of the first electrode plate 100 at the bending regions increases with the increasing number of winding turns, resulting in an increase in the length of the first electrode plate 100 at the bend regions C. Since the spacing between any two adjacent third laminated regions B is the same, the positions of the first-side laminated regions B1 and the second-side laminated regions B2 on different winding turns will vary as the number of winding turns increases.

Specifically, the first electrode plate 100 includes a first winding turn, which is wound at least one turn in a length direction from a winding start end thereof, and an Nth winding turn, which is wound at least one turn in the length direction to a winding finish end thereof. The first winding turn includes a first bend region C1 and a second bend region C2, where the first bend region C1 is a region where the first electrode plate 100 is bent for the first time, and the second bend region C2 is a region where the first electrode plate 100 is bent for the second time. On the upper side of the battery cell, the first-side laminated region B1 on the first winding turn is disposed adjacent to the first bend region C1. From the first winding turn to the Nth winding turn, the spacing between the first-side laminated region B1 and the first bend region C1 gradually increases. As shown in FIG. 17, on the upper side of the battery cell, the first-side laminated region B1 gradually shifts leftward from the first winding turn to the Nth winding turn as the number of winding turns increases. On the lower side of the battery cell, the second-side laminated region B2 on the first winding turn is disposed adjacent to the second bend region C2. From the first winding turn to the Nth winding turn, the spacing between the second-side laminated region B2 and the second bend region C2 gradually increases. As shown in FIG. 17, on the lower side of the battery cell, the second-side laminated region B2 gradually shifts rightward from the first winding turn to the Nth winding turn as the number of winding turns increases.

Based on the above embodiment, on the upper side of the battery cell, the first-side laminated region B1 on the first winding turn has a first end disposed close to the first bend region C1. A spacing between one end of the first-side laminated region B1 on the Nth winding turn that is close to the first bend region C1 and the first end satisfies the following relationship:

$$An = ( N - 1 ) 2 \times π \times B$$

where An represents the spacing between the end of the first-side laminated region B1 on the Nth winding turn that is close to the first bend region C1 and the first end; and B=R3−R2, where R3 represents the radius of the first electrode plate 100 of the Nth winding turn with the center at the bend region C, and R2 represents the radius of the first electrode plate 100 of the (N-1)th winding turn with the center at the bend region C. In other words, B represents the sum of the thicknesses of the first electrode plate 100, the second electrode plate 200 and the first separator 300.

Based on the above embodiment, on the lower side of the battery cell, the second-side laminated region B2 on the first winding turn has a second end disposed adjacent to the second bend region C2. A spacing between one end of the second-side laminated region B2 on the Nth winding turn that is close to the second bend region C2 and the second end satisfies the following relationship:

$${An}^{′} = ( N - 1 ) \times N \times π \times B$$

where An′ represents the spacing between the end of the second-side laminated region B2 on the Nth winding turn that is close to the second bend region C2 and the second end, and B represents the sum of the thicknesses of the first electrode plate 100, the second electrode plate 200 and the first separator 300.

In this embodiment, by defining An and An′ within the above ranges, the uniformity of the thickness of the battery cell can be further improved, thereby further reducing the thickness of the battery cell and facilitating an increase in the energy density of the battery cell.

By way of example, as shown in FIG. 17, during the winding of the battery cell using a winding mandrel, the first winding turn of the first electrode plate 100 fits against the winding mandrel. A first end of the first-side laminated region B1 on the first winding turn is defined as A1, and a second end of the second-side laminated region B2 on the first winding turn is defined as A1′;
the end of the first-side laminated region B1 on the second winding turn that is close to the first bend region C1 is defined as A2, and the end of the second-side laminated region B2 on the second winding turn that is close to the second bend region C2 is defined as A2′; the end of the first-side laminated region B1 on the third winding turn that is close to the first bend region C1 is defined as A3, and the end of the second-side laminated region B2 on the third winding turn that is close to the second bend region C2 is defined as A3′; the end of the first-side laminated region B1 on the fourth winding turn that is close to the first bend region C1 is defined as A4, and the end of the second-side laminated region B2 on the fourth winding turn that is close to the second bend region C2 is defined as A4′; by analogy, the end of the first-side laminated region B1 on the Nth winding turn that is close to the first bend region C1 is defined as An, and the end of the second-side laminated region B2 on the Nth winding turn that is close to the second bend region C2 is defined as An′, then:

$$A 1 = 0 ; A {1}^{′} = 0$$

$$A 2 = π \times B ; A {2}^{′} = A 2 + π \times B = 2 \times π \times B = 1 \times 2 \times π \times B ;$$

$$A 3 = A {2}^{′} + 2 \times π \times B = 4 \times π \times B = {2}^{2} \times π \times B ;$$

$$A {3}^{′} = A 3 + 2 \times π \times B = 6 \times π \times B = 2 \times 3 \times π \times B ;$$

$$A 4 = A {3}^{′} + 3 \times π \times B = 9 \times π \times B = {3}^{2} \times π \times B ;$$

$$A {4}^{′} = A 4 + 3 \times π \times B = 12 \times π \times B = 3 \times 4 \times π \times B ;$$

$$…$$

$$An = {( N - 1 )}^{2} \times π \times B ; {An}^{′} = ( N - 1 ) \times N \times π \times B .$$

Based on the above embodiment, the spacing between the first end of the first-side laminated region B1 and the second end of the second-side laminated region B2 is defined as W, i.e. the spacing between A1 and A1′ is defined as W, where An≤W, and An′≤W. As a result, it can be ensured that the first-side laminated region B1 and the second-side laminated region B2 are both located in the straight regions, thereby preventing the first-side laminated region B1 and the second-side laminated region B2 from being located in the bend regions C. This enables length compensation for the first electrode plate 100 at the bend regions C, thereby preventing breakage of the first electrode plate 100 caused by tensile force or bulging of the second electrode plate 200, thereby facilitating an improvement in the safety performance of the battery cell. Moreover, by locating the first-side laminated region B1 and the second-side laminated region B2 in the straight regions, the coverage stability of the first electrode plate 100 and the second electrode plate 200 can be improved, and the bonding strength between the first electrode plate 100, the first separator 300, the second electrode plate 200 and the second separator 400 can be increased.

In this embodiment, on the upper side of the battery cell, from the first winding turn to the Nth winding turn, as the number of winding turns increases, the spacing between the first-side laminated region B1 and the first bend region C1 gradually increases. Consequently, from the first winding turn to the Nth winding turn, as the number of winding turns increases, the overlapping area between projections of the first-side laminated regions B1 on two adjacent winding turns in the thickness direction of the battery cell gradually decreases. By way of example, the overlapping area between projections of the first-side laminated region B1 on the first winding turn and the first-side laminated region B1 on the second winding turn in the thickness direction of the battery cell is defined as S1; the overlapping area between projections of the first-side laminated region B1 on the second winding turn and the first-side laminated region B1 on the third winding turn in the thickness direction of the battery cell is defined as S2; by analogy, the overlapping area between projections of the first-side laminated region B1 on the Nth winding turn and the first-side laminated region B1 on the (N-1)th winding turn in the thickness direction of the battery cell is defined as Sn-1, then S1>S2> . . . >Sn-1, where Sn-1 may be zero, meaning that the projections of the first-side laminated region B1 on the Nth winding turn and the first-side laminated region B1 on the (N-1)th winding turn in the thickness direction of the battery cell do not overlap at all. In this embodiment, no further limitation is imposed on the number of adjacent winding turns on which the first-side laminated regions B1 have projections in the thickness direction of the battery cell that do not overlap at all. A person skilled in the art may set the number according to actual requirements.

On the lower side of the battery cell, from the first winding turn to the Nth winding turn, as the number of winding turns increases, the spacing between the second-side laminated region B2 and the second bend region C2 gradually increases. Consequently, from the first winding turn to the Nth winding turn, as the number of winding turns increases, the overlapping area between projections of the second-side laminated regions B2 on two adjacent winding turns in the thickness direction of the battery cell gradually decreases. By way of example, the overlapping area between projections of the second-side laminated region B2 on the first winding turn and the second-side laminated region B2 on the second winding turn in the thickness direction of the battery cell is defined as S1′; the overlapping area between projections of the second-side laminated region B2 on the second winding turn and the second-side laminated region B2 on the third winding turn in the thickness direction of the battery cell is defined as S2′; by analogy, the overlapping area between projections of the second-side laminated region B2 on the Nth winding turn and the second-side laminated region B2 on the (N-1)th winding turn in the thickness direction of the battery cell is defined as Sn-1′, then S1′>S2′> . . . >Sn-1′, where Sn-1′ may be zero, meaning that the projections of the second-side laminated region B2 on the Nth winding turn and the second-side laminated region B2 on the (N-1)th winding turn in the thickness direction of the battery cell do not overlap at all. In this embodiment, no further limitation is imposed on the number of adjacent winding turns on which the second-side laminated regions B2 have projections in the thickness direction of the battery cell that do not overlap at all. A person skilled in the art may set the number according to actual requirements.

Based on the above embodiment, the battery cell further includes an insulation layer 500. When the first electrode plate 100 and the second electrode plate 200 are wound to form the battery cell, the first electrode plate 100 is located on the outermost side of the battery cell. The insulation layer 500 is attached to the winding finish end of the first electrode plate 100, and can provide insulation protection for the winding finish end of the first electrode plate 100, thereby enhancing the safety of the battery cell.

As an optional embodiment, a projection of the insulation layer 500 in the thickness direction of the battery cell overlaps at least partially with at least one third laminated region B, that is, the projection of the insulation layer 500 in the thickness direction of the battery cell may overlap with the projection of the at least one third laminated region B in the thickness direction of the battery cell, or the projection of the insulation layer 500 in the thickness direction of the battery cell may completely coincide with the projection of the at least one third laminated region B in the thickness direction of the battery cell.

In this embodiment, the number of third laminated regions B and the number of non-third laminated regions A are not specifically limited. Those skilled in the art may set the number of third laminated regions B and the number of non-third laminated regions A according to actual requirements, which are not further limited in this embodiment.

In this embodiment, the first electrode plate 100 further includes a first tab 17a. The first tab 17a is connected to the first current collector, and the first tab 17a is configured to lead out one electrode of the battery cell. The second electrode plate 200 further includes a second tab 17b. The second tab 17b is connected to the second current collector, and the second tab 17b is configured to lead out the other electrode of the battery cell.

The embodiments of the present application further provide a battery, which includes a casing and the battery cell 10 described in the above technical solutions. The battery cell 10 is disposed in the casing or in a pouch enclosure, and the casing may be filled with an electrolyte.

The embodiments of the present application provide a battery cell 10 and a battery. The battery cell 10 may be of a wound configuration. The battery cell 10 includes a first electrode plate 100, a first separator 300, a second electrode plate 200 and a second separator 400 which are stacked in sequence. At least one of a head portion and a tail portion of the first electrode plate 100 has an uncoated foil surface 110. The uncoated foil surface 110 faces the first separator 300, an adhesive layer 120 is provided on the uncoated foil surface 110, and the first separator 300 is bonded to the first electrode plate 100 via the adhesive layer 120, such that the battery cell 10 can be wound as a whole, thereby avoiding problems such as wrinkling and electrode plate misalignment at the beginning and end of a winding process, and improving product yield.

In the description of the present application, it should be noted that, unless expressly stated and defined otherwise, the terms “mounted”, “connected”, and “connection” should be understood in a broad sense, for example, it may be a fixed connection, or an indirect connection through an intermediate medium, and may be the communication between the interiors of two elements or the interaction between two elements. For those of ordinary skill in the art, the specific meaning of the terms mentioned above in the present application should be construed according to specific circumstances.

In the description of the embodiments of the present application, it should be understood that orientation or position relationships indicated by the terms such as “up”, “down”, “front”, “rear”, “left”, “right”, “vertical”, “horizontal”, “top”, “bottom”, “inside”, and “outside” are based on orientation or position relationships shown in the accompanying drawings and are merely for ease of description of the present application and simplification of the description, rather than indicating or implying that the apparatuses or elements referred to must have a specific orientation or be constructed and operated in a specific orientation, and therefore cannot be construed as limiting the present application.

The terms “first”, “second”, “third”, “fourth”, etc. (if any) in the description, claims and the above accompanying drawings of the present application are used for distinguishing similar objects, but are not intended to indicate any particular order or sequence. It should be understood that the data used in this way may be interchanged where appropriate, so that the embodiments of the present application described herein can be implemented in an order other than those illustrated or described herein.

In addition, the terms “include”, “have” and any variation thereof are intended to cover a non-exclusive inclusion, for example, a process, method, system, product, or device that includes a series of steps or units is not necessarily limited to those steps or units that are explicitly listed, but may include other steps or units not explicitly listed or inherent to such a process, method, product or device.

It should be finally noted that the above embodiments are merely used for illustrating rather than limiting the technical solutions of the present application. Although the present application has been illustrated in detail with reference to the foregoing embodiments, it should be understood by those of ordinary skill in the art that the technical solutions described in the foregoing embodiments may still be modified, or some or all of the technical features thereof may be equivalently substituted; and these modifications or substitutions do not make the essence of the corresponding technical solution depart from the scope of the technical solutions of the embodiments of the present application.

1. A battery cell, comprising a first electrode plate, a first separator, a second electrode plate and a second separator which are stacked in sequence, wherein the first separator and the second separator are respectively located on two sides of the second electrode plate, and the first separator is located between the first electrode plate and the second electrode plate; and
at least one of a head portion and a tail portion of the first electrode plate has an uncoated foil surface, the uncoated foil surface facing the first separator and being provided with an adhesive layer via which the first separator is bonded to the first electrode plate.

2. The battery cell according to claim 1, wherein the uncoated foil surface comprises a first uncoated foil surface and a second uncoated foil surface, and the adhesive layer comprises a first adhesive layer and a second adhesive layer; the first uncoated foil surface is located at the head portion of the first electrode plate, and the first adhesive layer is bonded between the first uncoated foil surface and the first separator to form a first laminated region; and the second uncoated foil surface is located at the tail portion of the first electrode plate, and the second adhesive layer is bonded between the second uncoated foil surface and the first separator to form a second laminated region.

3. The battery cell according to claim 2, wherein the battery cell comprises a third laminated region located between the first laminated region and the second laminated region in an X-direction, the first electrode plate, the first separator, the second electrode plate and the second separator in the third laminated region being sequentially bonded to one another.

4. The battery cell according to claim 3, wherein a plurality of third laminated regions are provided, which are arranged at intervals in a winding direction of the battery cell.

5. The battery cell according to claim 4, wherein along a length direction of the first electrode plate, a spacing between any two adjacent ones of the third laminated regions is the same.

6. The battery cell according to claim 4, wherein the plurality of third laminated regions are equal in length.

7. The battery cell according to claim 4, wherein the battery cell comprises a compensation region, a length of the first electrode plate corresponding to the compensation region is greater than a length of the second electrode plate corresponding to the compensation region, and the compensation region is located between adjacent third laminated regions.

8. The battery cell according to claim 4, wherein between any two adjacent third laminated regions, a difference in length between the first electrode plate and the second electrode plate satisfies the following relationship:
$$La = π \times a$$
wherein La represents the difference in length between the first electrode plate and the second electrode plate, and a represents the sum of half a thickness of the first electrode plate, half a thickness of the second electrode plate, and a thickness of the first separator.

9. The battery cell according to claim 4, wherein spacings between adjacent third laminated regions follow an increasing arithmetic progression from the head portion of the first electrode plate to the tail portion of the first electrode plate.

10. The battery cell according to claim 7, wherein the battery cell comprises curved segments and straight segments connected alternately in the winding direction, the third laminated regions are located on the straight segments, and the compensation regions are located on the curved segments.

11. The battery cell according to claim 4, wherein the battery cell comprises N winding turns, N≥1, N being an integer, and two of the third laminated regions are provided on each of the winding turns and defined as a first-side laminated region and a second-side laminated region, respectively,
wherein the battery cell comprises a first side and a second side, which are located on two sides of the battery cell in a thickness direction of the battery cell, the first-side laminated region of each winding turn is located on the first side, and the second-side laminated region of each winding turn is located on the second side; and
projections of the first-side laminated region and the second-side laminated region in the thickness direction of the battery cell do not overlap.

12. The battery cell according to claim 11, wherein the first electrode plate comprises a first winding turn, which is wound at least one turn in a length direction from a winding start end thereof, and an Nth winding turn, which is wound at least one turn in the length direction to a winding finish end thereof, wherein the first winding turn comprises a first bend region and a second bend region;
on the first side, the first-side laminated region located on the first winding turn is close to the first bend region, and from the first winding turn to the Nth winding turn, a spacing between the first-side laminated region and the first bend region gradually increases;
and/or on the second side, the second-side laminated region located on the first winding turn is close to the second bend region, and from the first winding turn to the Nth winding turn, a spacing between the second-side laminated region and the second bend region gradually increases.

13. The battery cell according to claim 12, wherein on the first side, from the first winding turn to the Nth winding turn, an overlapping area between projections of the first-side laminated regions on adjacent winding turns in the thickness direction of the battery cell gradually decreases;
and/or on the second side, from the first winding turn to the Nth winding turn, an overlapping area between projections of the second-side laminated regions on adjacent winding turns in the thickness direction of the battery cell gradually decreases.

14. The battery cell according to claim 12, wherein on the first side, the battery cell comprises N first-side laminated regions; the first-side laminated region located on the first winding turn has a first end, the first end being close to the first bend region; and a spacing between one end of the first-side laminated region on the Nth winding turn that is close to the first bend region and the first end satisfies the following relationship:
$$An = ( N - 1 ) 2 \times π \times B$$
wherein An represents the spacing between the end of the first-side laminated region on the Nth winding turn that is close to the first bend region and the first end, and B represents the sum of thicknesses of the first electrode plate, the second electrode plate and the first separator.

15. The battery cell according to claim 14, wherein on the second side, the battery cell comprises N second-side laminated regions; the second-side laminated region located on the first winding turn has a second end, the second end being close to the second bend region; and a spacing between one end of the second-side laminated region on the Nth winding turn that is close to the second bend region and the second end satisfies the following relationship:
$${An}^{′} = ( N - 1 ) \times N \times π \times B$$
wherein An′ represents the spacing between the end of the second-side laminated region on the Nth winding turn that is close to the second bend region and the second end, and B represents the sum of the thicknesses of the first electrode plate, the second electrode plate and the first separator.

16. The battery cell according to claim 15, wherein a spacing between the first end and the second end is defined as W, wherein An≤W, and/or An′≤W.

17. The battery cell according to claim 1, wherein the first electrode plate comprises a substrate and active layers, the active layers being coated on two side surfaces of the substrate, and the adhesive layer has a dimension T1 in a Y-direction that is smaller than a dimension T2 of each active layer in the Y-direction, wherein 0.001 mm<T1<0.5 mm.

18. The battery cell according to claim 1, wherein the adhesive layer has a dimension greater than or equal to 2 mm in the X-direction.

19. The battery cell according to claim 2, wherein an insulation layer is further applied to the winding finish end of the first electrode plate, and a projection of the insulation layer in the thickness direction of the battery cell overlaps at least partially with at least one of the first laminated region and the second laminated region.

20. A battery, comprising a casing and a battery cell according to claim 1, wherein the battery cell is disposed in the casing or in a pouch enclosure.
